(19) United States
(12) Patent Application Publication
(10) Pub. No.: US 2008/0277065 A1
(43) Pub. Date: Nov. 13, 2008

(54) Hand-Held Labeling Apparatus Having Accessory Storage

(76) Inventors: Brett Moody, Chicago, IL (US); David M. Hines, Santa Ana, CA (US); Alan Rushing, Irvine, CA (US)

Correspondence Address: MOORE & HANSEN, PLLP, 225 SOUTH SIXTH ST, MINNEAPOLIS, MN, 55402, US

(21) Appl. No.: 11/745,897

(22) Filed: May 8, 2007

(51) Int. Cl. B65C 11/00

(52) U.S. Cl. 156/384

(57) ABSTRACT

A hand-held manually operated labeling apparatus has at least one accessory storage chamber designed to improve a user's ability to use the apparatus. A variety of configurations and locations for the storage chamber are preferred. Preferred accessories are additional ink cartridges and printed information sheets.

### TECHNICAL FIELD

This application involves the type of hand-held labeling apparatus used to apply individual labels onto items (such as goods in retail stores).

### BACKGROUND

Hand-held labeling devices are known and used in manufacturing, distribution, and retail environments, among many others. Labels may be applied as they are supplied by the label manufacturer, or the apparatus may contain a printing mechanism that applies ink to individual labels so that the printed labels may then be applied to individual items. Changing the information to be printed by the printing mechanism enables the employee to apply different labels to different items for extended periods of time. For example, hand-held labeling devices are often used to print and apply price, date or time information to goods. This is often used to convey a manufacturing date, or in the case of food products, a “use by” date. Sometimes these dates can be coded so that someone requires knowledge of this code to decipher the date information. Hand-held labeling devices can be used to print and apply manufacturing, shipping, quality control information such as batch numbers. This information is often displayed in the form of a series of numbers and/or letters. Hand-held labeling devices can be used to simply dispense labels, without printing anything on the labels. Examples of this are the dispensing of promotional labels, such as a preprinted “Sale” labels.

In certain types of known hand-held labeling apparatus, particularly certain of those typically associated with applying labels to items, the apparatus may employ a small, replaceable (typically cylindrical) ink cartridge (typically called an “ink roller” when it is cylindrical in shape). The ink cartridge mechanically applies ink to a print head, which in turn applies ink to an individual label that proceeds on a path though the apparatus. In those types of hand-held labeling apparatus employing a replaceable ink cartridge, the ink stored in the cartridge is used up over time, and replacement of the cartridge is required.

Such replacement, as well as other periodic maintenance procedures (including reloading label stock, changing print settings, and the like) is performed by users of the apparatus who may or may not be experienced in maintenance and operation of the apparatus. Thus, some users may not readily know how to perform such tasks. Even experienced users may be required to locate instructions to learn how to perform less common tasks. If the replacement supplies or needed information are not readily available to the user, their productivity suffers as they search for these items.

Therefore, there is a need for an improved hand-held labeling apparatus that enables users to improve their productivity associated with maintenance and use of the apparatus.

### SUMMARY

A hand-held manually operated labeling apparatus has at least one accessory storage chamber designed to improve a user's ability to use the apparatus. One type of chamber may be within, affixed, or otherwise attached to the apparatus for an additional ink cartridge. Another type of chamber may be within, affixed, or otherwise attached to the apparatus to enable printed information to be combined with the apparatus so that the information is readily available to the user. A single chamber may accommodate more than one type of accessory.

### BRIEF DESCRIPTION OF THE DRAWINGS

The accompanying drawings show a particular embodiment of the invention as an example, and are not intended to limit the scope of the invention.

FIG. 1 is a schematic view of one embodiment of a hand-held labeling apparatus, illustrated in top, left side, front, and right side views.

FIGS. 2-15 are each is a schematic view of another embodiment of a hand-held labeling apparatus, with FIGS. 2-10 and 13-16 each being a perspective view from one of a variety of angles, and FIGS. 11-12 each being a side view.

FIG. 17 is an illustration of a component of the embodiment of FIG. 12.

### DETAILED DESCRIPTION

In general terms, a preferred improved hand-held labeling apparatus may include features designed to improve a user's ability to use the apparatus at an overall high level of productivity. One such feature is a storage chamber within, affixed, or otherwise attached to the apparatus for an accessory such as an additional ink roller or a message slug. The second feature is printed information affixed to or combined with the apparatus so that the information is readily available to the user.

More specifically, a hand-held labeling apparatus may comprise: (a) a body defining a path for a label to proceed through the body; (b) a dispensing mechanism along the path for dispensing the label after printing; (c) a hand-operated label advancing mechanism for moving the label along the path from a source of the labels to the printing mechanism and then to the dispensing mechanism; and (d) a chamber of the body, not on the path, and adapted for storage of an accessory for the apparatus. It is preferred but not required that the apparatus further comprise a printing mechanism along the path for printing the label. In such case, it is further preferred but not required that the printing mechanism comprise a replaceable ink roller. However, a printing mechanism is not required, and the labels may be pre-printed (or otherwise pre-prepared).

In use, the label advancing mechanism typically includes a user-operated actuator (e.g., a squeezable handle), so that a repeated series of actuation cycles moves a steady supply of labels along the path a predetermined distance. If a printing mechanism is included on the path, a cycle of actuation will print and dispense a label.

Another common, but not required, feature is that the label stock be in the form of a roll of web-backed adhesive labels, with the dispensing mechanism also separating each label from the web so that the label may be applied by use of the adhesive.

One of the benefits of the invention follows from the improvements to productivity of the user of the apparatus, increased yield of the ink cartridge stock, and improved print quality. Currently, spare ink cartridges (often in the form of rollers) must be stored separately from the labeling apparatus. When replacement of the ink cartridge is required, the replacement stock may be lost, difficult to find, not readily available, or not conveniently located. The user is also inconvenienced because they must stop whatever work they are doing and travel to the location of the replacement stock. In the case of a user who is not working at a fixed location, such as a delivery driver, finding a replacement ink cartridge can be an even greater loss of productivity. Many users will allow the quality of the printing to decrease due to insufficient ink supply before they change the ink cartridge.

Furthermore, the available supply of cartridges may include stock of more than one type of ink cartridge, which can lead to an incorrect selection and potentially a wasted ink cartridge. While instructions for selecting and installing the proper cartridge may exist, they may not be packaged together with the ink cartridge itself, or they may not provide sufficient detail for the user to perform the replacement properly.

By contrast, storage of one or more spare ink cartridges on or within the body of the labeling apparatus provides the user with an immediate source for a replacement ink cartridge, without the user leaving the workplace or losing productivity. It also substantially reduces the chances of selecting the wrong ink cartridge. It is also possible to include replacement ink cartridge information (e.g., the required replacement cartridge model number) adjacent to or inside the storage location for ready reference. Other types of accessories may be stored in a similar manner (e.g., a “message slug” that enables a user to customize individual labels when such types of printing mechanism are included).

Also, inclusion of a printed information sheet attached to (or stored within, or both) the apparatus reduces errors in the operation of the apparatus. Such operation may include any of: (1) replacement of the ink cartridge (if present) by the user; (2) loading of replacement labels; (3) adjustment of printing alignment on the labels; (4) installation, use, or removal of the accessory message slug; (5) selecting different printed characters (or fonts); and (6) maintenance of the apparatus. While such devices are typically designed for simple operation, they can require some operational steps that can be confusing to a user. In addition, typically there are fewer devices in use than there are potential users (i.e., fewer devices owned by a store than the number of employees of the store who use the devices). Thus, it is very possible that novice users will be required to operate them, perhaps after receiving little or no training. A separate user guide may become misplaced or lost, but an instruction guide integrated with the apparatus itself is always available to the user.

These instructions (or any other form of information accessory) may be in the form of a printed card or booklet, and may be made from a variety of materials, including plastic and paper. In addition to user instructions, other information related to the use of the labeling apparatus may be included, such as reference tables, product codes, pricing information, product location information, and company policies. The printed information may be fan-folded, accordion-folded, rolled, or otherwise arranged to reduce its volume when stored. It may be attached to the apparatus so that it extends from the apparatus when unfurled, or it may be a separate piece combined with the apparatus.

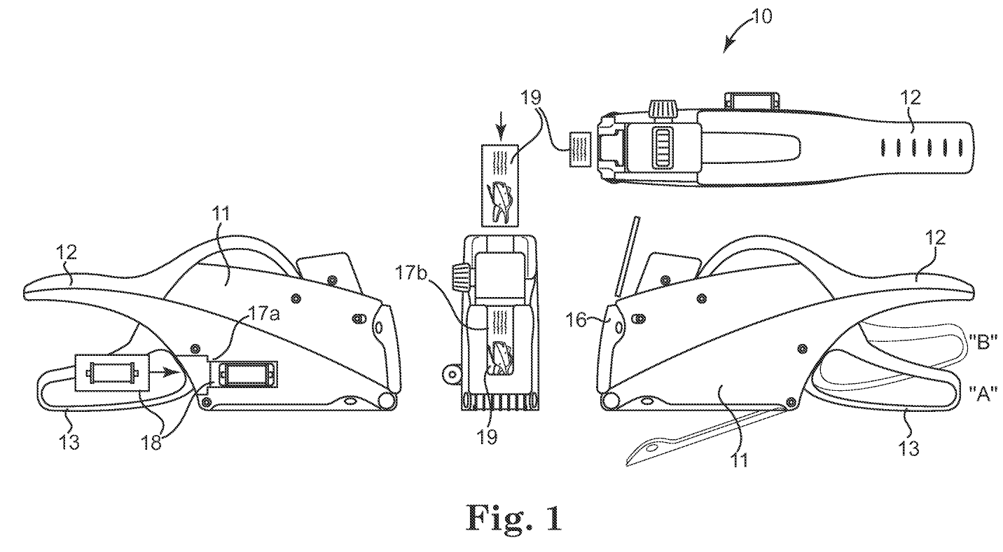

Referring to the embodiments schematically illustrated in the drawings, FIG. 1 is generally representative of an entire hand-held labeling apparatus 10, which is illustrated to comprise a body 11, a first handle 12, and a second, movable handle 13 movably mounted to the body 11. Movable handle 13 is illustrated both in its rest or fully extended position “A” and another position “B” that results from the user squeezing the handles together. Such motion causes the apparatus to operate in a known manner. Specifically, a location in the upper part of the apparatus 10 contains a supply (often a roll) of labels (not shown), which may be installed to enable individual labels to travel along an internal path through the apparatus. As movable handle 13 cycles repeatedly, a label advances along the path from the label supply to optional printing of the label, to delivery of the label to a position from which it may leave the apparatus and be applied to an article (not shown and not part of the apparatus).

Certain components of the apparatus (when present) may be conventional and may therefore be defined in functional terms: a body defining a path for a label to proceed through the body; a printing mechanism along the path for printing the label (the printing mechanism comprising a replaceable ink cartridge); (c) a dispensing mechanism along the path for dispensing the label after printing; and (d) a label advancing mechanism for moving the label along the path from the printing mechanism to the dispensing mechanism. Replacement of the ink cartridge requires accessing the installed ink cartridge, removing the installed cartridge, and replacing it with a new replacement cartridge.

As illustrated, a chamber 17a of body 11 (in the example illustrated) is configured (shaped and sized) to removably hold an accessory 18 for the apparatus 10. Similarly, a chamber 17b of body 11 (in the example illustrated) is configured (shaped and sized) to removably hold an accessory 19 for the apparatus 10. The most preferred accessories are a spare ink cartridge 18 (which may be packaged in disposable packaging appropriate to the configuration), a multi-paneled printed information sheet 19, and a message slug (not illustrated).

For example, in the preferred embodiment of FIG. 1, chamber 17a includes a pair of opposing grooves formed in the exterior side of the body. The grooves define a region between themselves that is configured (shaped and sized) to removably (e.g., frictionally) hold a spare ink cartridge which is packaged in disposable packaging (such as a cardboard-backed plastic blister). The packaged ink cartridge 18 is inserted without removal of the ink cartridge from the packaging, which helps prevent the ink cartridge from drying out prematurely.

Apparatus 10 also provides storage for an information sheet 19. The sheet is designed to fold into a smaller volume and may be entirely separate from the apparatus but combinable with the apparatus by use of a properly configured chamber 17b. In FIG. 1 the sheet (when folded) fits into a pair of opposing grooves formed in the exterior front face of the body that define a region between themselves that is configured (shaped and sized) to removably hold the folded separate sheet, yet enable the sheet to be seen when it is in place between the grooves.

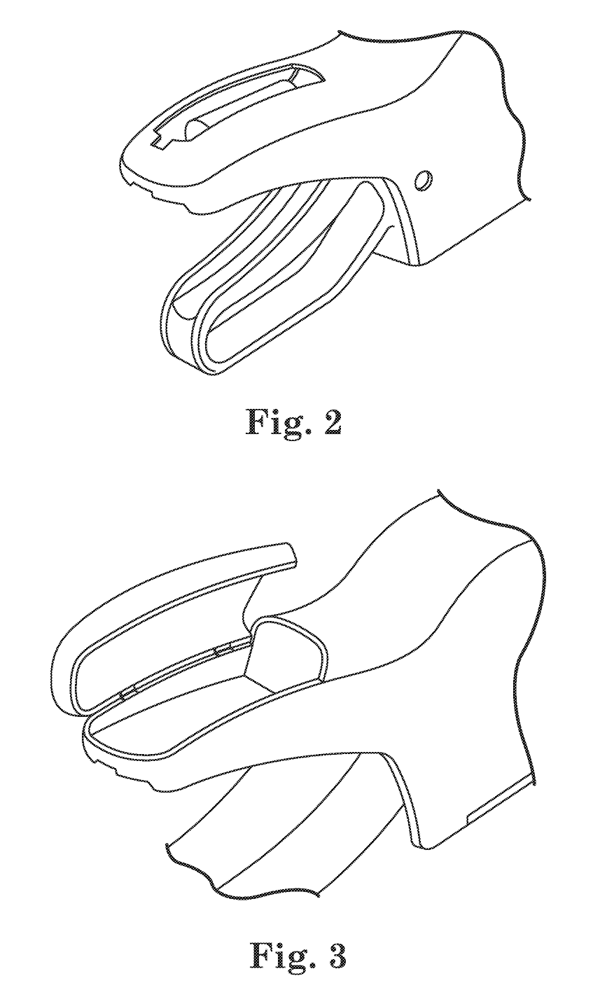

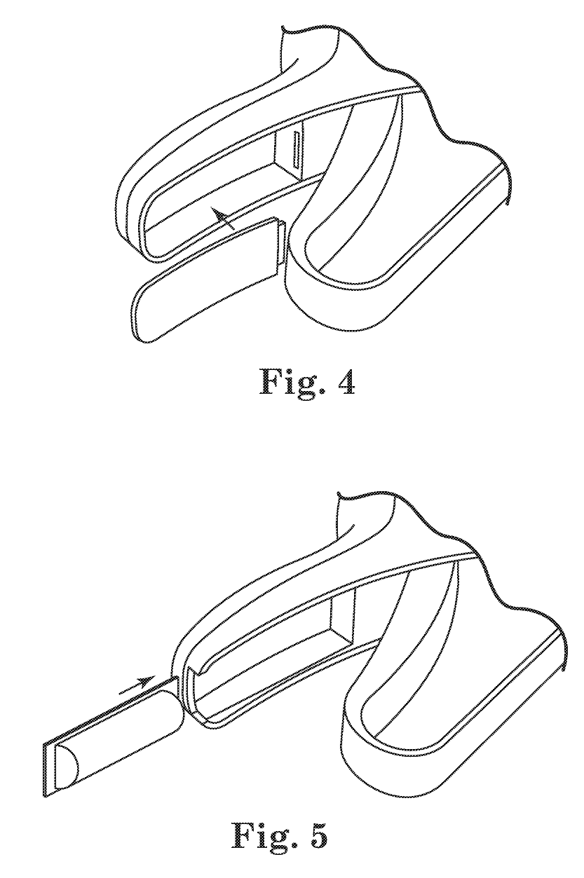

FIGS. 2-7 illustrate alternative locations and configurations for the storage chamber. FIGS. 2-4 illustrate that the chamber may be a cavity formed within handle 12. In FIGS. 2 and 3, the cavity is open to the upper portion of handle 12. FIG. 4 illustrates an embodiment like that of FIG. 2, but in which the cavity is open to the lower side of handle 12. FIG. 7 illustrates an embodiment in which the cavity is formed within handle 13, specifically one in which the cavity is open to the upper side of handle 13. It is possible for the cavity to be open to the lower side of handle 13 provided that it does not interfere with the ergonomic criterion that the handle is easy to grip and repeatedly squeeze during normal operation of the apparatus.

In addition, FIGS. 2, 4 and 7 illustrate an optional cover for the cavity that may be formed from a separate snap-on (or otherwise attachable but removable) cover. FIG. 3 illustrates a hinged cover. A sliding cover, whether it be one that slides into the interior of the body, or one that is partially or wholly removable by sliding away from its fully closed position, may also be provided. When a cover (of any type) is used, it is desirable (but not required) for the contents of the cavity to be visible to some extent through the cover, e.g., a transparent plastic cover. The cover may be opaque, clear (non-colored), or colored (semi-transparent) to coordinate with the color of the handle or other portions of the apparatus.

A similar type of alternative configuration is shown in FIG. 16, in which a movable portion of the handle provides at least partial access to the storage chamber. The figure illustrates a completely removable portion (providing complete access), but a hinged or otherwise temporarily movable portion is also within the scope of the invention. The storage chamber may be entirely within the movable portion, or shared between the movable portion and the balance of the handle. It is also illustrated, but optional, to include a viewing window to determine the contents of the cavity when the movable portion of the handle is in its closed position. The location of a storage chamber of this type within the handle, as opposed to within the body of the apparatus, is an example only, as both locations are within the scope of the invention.

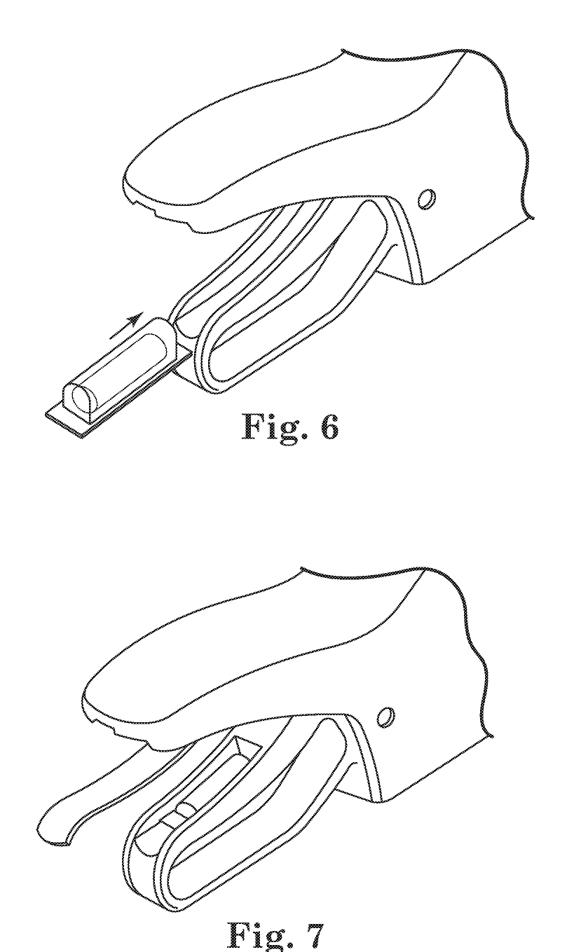

FIGS. 2-4, 7, and 16 are embodiments in which the replacement ink cartridge is placed within the cavity and kept in place until use. By contrast, the embodiments of FIGS. 5 and 6 illustrate embodiments in which the accessory (as illustrated, a packaged ink cartridge) is between opposing grooves as described above with respect to FIG. 1. FIG. 5 illustrates such grooves located on the lower side of handle 12. FIG. 6 illustrates such grooves on the upper side of handle 13.

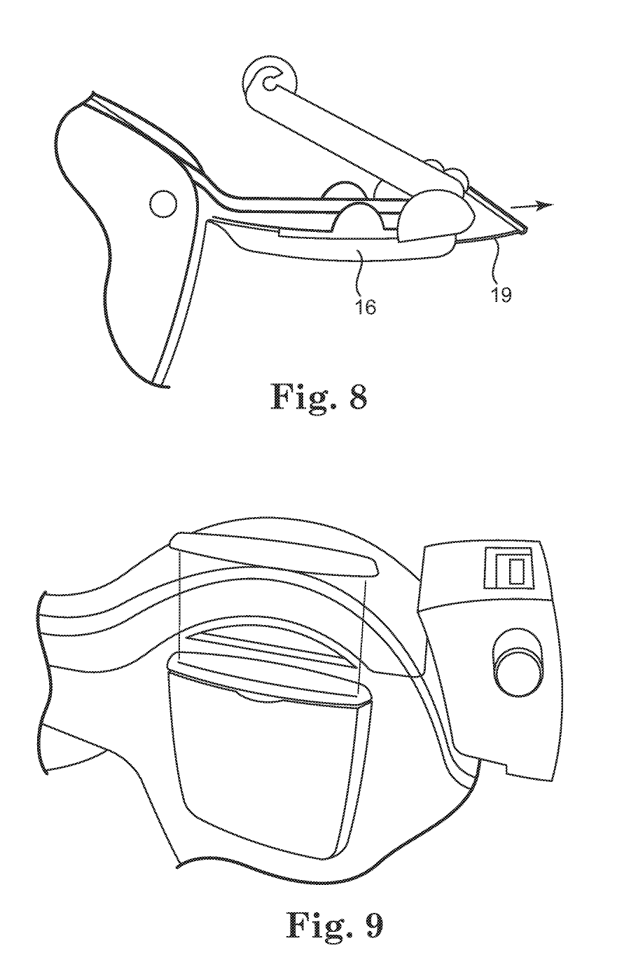

FIG. 8 illustrates an embodiment in which the accessory information sheet is not folded but instead is rolled onto a reel to form a scroll-like accessory stored within the access door 16.

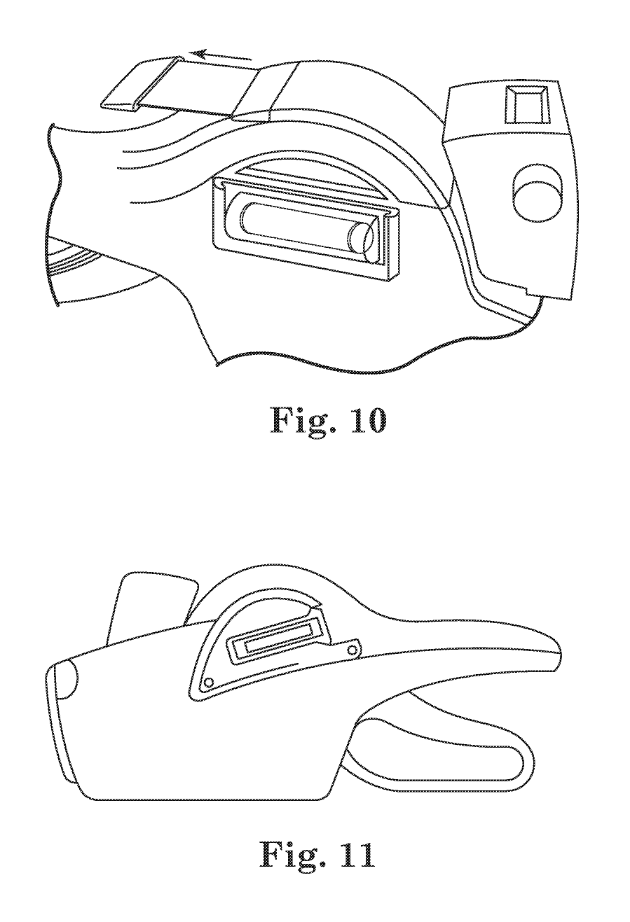

FIG. 9 illustrates an embodiment in which the accessory information sheet is extractable from a chamber located on the apparatus. FIG. 10 illustrates a similar embodiment in which the accessory information sheet is extractable from a chamber located on the top of the apparatus. FIG. 10 also illustrates that a second storage chamber may be included for storage of an additional accessory such as a replacement ink cartridge.

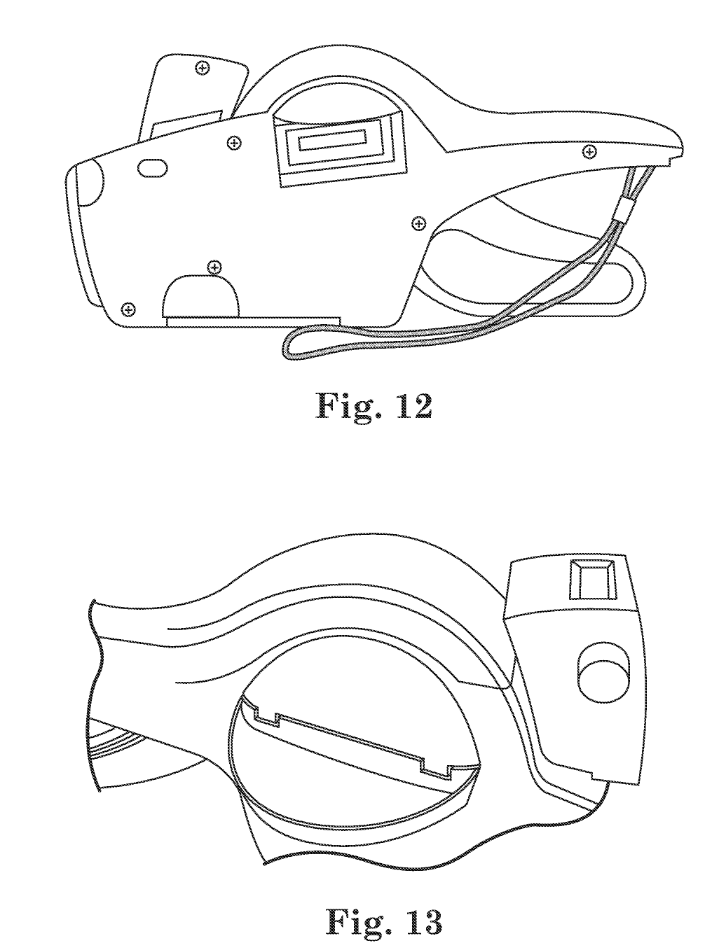

FIGS. 11 and 12 illustrate that a storage chamber may be provided in a form which is not integral with the apparatus but instead is a separate piece combinable with or mountable to the apparatus. The chamber illustrated in FIG. 11 is designed to be attached to the apparatus. The chamber illustrated in FIG. 12 (and shown in detail in FIG. 17) may be adhered or otherwise affixed to the apparatus, perhaps in the field as an aftermarket product.

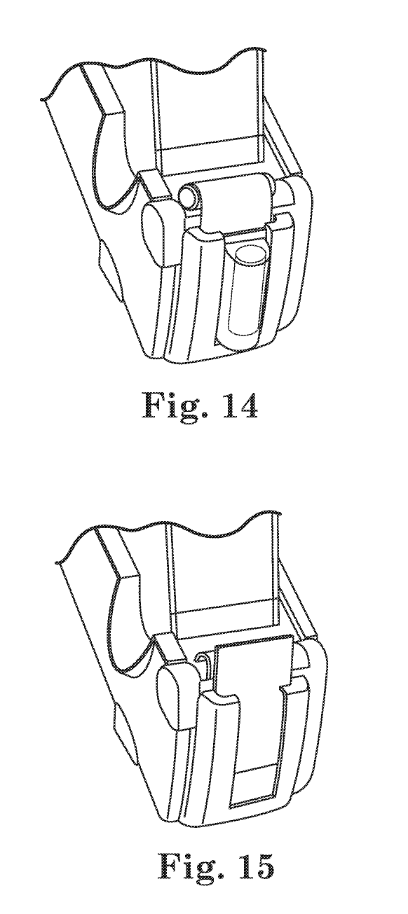

FIG. 13 illustrates a storage chamber for one or more accessories, such as both the preferred ink cartridge and preferred information sheet, or other accessories. The chamber comprises a hinged cover for a storage location large enough to accommodate one or more accessories.

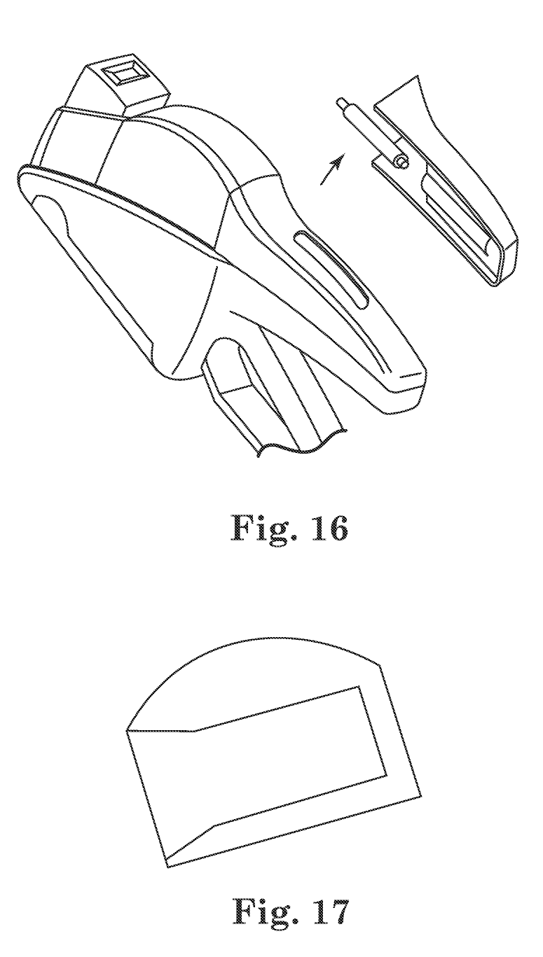

FIGS. 14 and 15 illustrate a storage chamber located on the front face of the apparatus. In FIG. 14, the chamber is configured as a pair of opposing grooves for holding an ink cartridge as described above for FIGS. 5, 6, and 10-12. In FIG. 15, the same chamber holds a folded printed information sheet as described above for FIG. 1. The storage chamber is illustrated in more detail in FIG. 17.

Those mechanistic aspects of the hand-held labeler that perform certain functions as described above may be replaced with equivalent means for performing the same respective function(s) without any change to the scope of the apparatus.

While the Figures that illustrate storage of an ink cartridge in a blister package do so in configurations in which the ink cartridge extends away from the exterior of the apparatus, it is possible to store the ink cartridge in a suitably configured cavity in which the cartridge extends into the cavity toward the interior of the apparatus.

While the Figures illustrate storage chambers adapted for either an ink cartridge or a printed information sheet, it will be apparent that a storage chamber incorporating the design elements of both types of storage may be constructed for the combined storage of an ink cartridge and a printed information sheet in the same location.

References to ink cartridge, printed information sheet, and message slug in the above description and the figures should be understood as exemplary in nature and not limited to those specific types of accessory except to the extent such limitations are expressly set forth in the following claims.

We claim:

1. A hand-held labeling apparatus, comprising:
a) a body defining a path for a label to proceed through the body;
b) a dispensing mechanism along the path for dispensing the label from the body;
c) a hand-operated label advancing mechanism for moving the label along the path to the dispensing mechanism; and
d) a chamber of the apparatus, not on the path, that is adapted for storage of an accessory for the apparatus.

2. The hand-held labeling apparatus of claim 1, in which the apparatus further comprises a printing mechanism.

3. The hand-held labeling apparatus of claim 2, in which the printing mechanism further comprises a replaceable ink cartridge.

4. The hand-held labeling apparatus of claim 3, in which the chamber provides for the apparatus to carry at least one additional ink cartridge to serve as a replacement for the replaceable ink cartridge.

5. The hand-held labeling apparatus of claim 1, in which the chamber provides for the apparatus to carry a printed sheet of information related to the apparatus.

6. The hand-held labeling apparatus of claim 1, in which the chamber provides for the apparatus to carry a message slug.

7. The hand-held labeling apparatus of claim 1, in which the apparatus further comprises a handle defining a cavity which serves as the chamber.

8. The hand-held labeling apparatus of claim 1, in which the chamber comprises a pair of opposing grooves defining a region between themselves that is configured to removably hold the accessory.

9. The hand-held labeling apparatus of claim 1, in which the chamber is a separate piece that is combinable with the apparatus.

10. The hand-held labeling apparatus of claim 1, in which the chamber is mountable to the apparatus.

11. The hand-held labeling apparatus of claim 1, in which the chamber is integral to the apparatus.

12. The hand-held labeling apparatus of claim 1, in which the apparatus further comprises a cover for the chamber.

13. The hand-held labeling apparatus of claim 1, in which the label advances along the path from a roll of web-backed label stock.

14. The hand-held labeling apparatus of claim 1, in which the label advancing mechanism further comprises a user-operated actuator for moving the label along the path and dispensing the label.

15. The hand-held labeling apparatus of claim 1, in which the apparatus further comprises a movable portion defining at least partially within itself a cavity which serves as the chamber, the cavity being at least partially accessible by moving the movable portion.

16. A hand-held labeling apparatus, comprising:
a) a body defining a path for a label to proceed through the body;
b) a means for dispensing the label from the body;
c) a hand-operated means for moving the label along the path to the means for dispensing; and
d) means for storing an accessory for the apparatus off the path.

17. The hand-held labeling apparatus of claim 15, in which the apparatus further comprises a means for printing the label.

18. The hand-held labeling apparatus of claim 17, in which the means for printing the label further comprises a replaceable ink cartridge.

19. The hand-held labeling apparatus of claim 15, in which the means for storing the accessory comprises a pair of opposing grooves defining a region between themselves that is configured to removably hold the accessory.

20. The hand-held labeling apparatus of claim 15, in which the means for storing the accessory defines a cavity in which the accessory may be stored.
